(19) United States
(12) Patent Application Publication
(10) Pub. No.: US 2012/0310552 A1
(43) Pub. Date: Dec. 6, 2012

(54) Detection Method and System for Array Substrate

(75) Inventor: Wen-Da Cheng, Guangdong (CN)

(73) Assignee: Shenzhen China Star Optoelectronics Technology Co. Ltd., Shenzhen City (CN)

(21) Appl. No.: 13/265,869

(22) PCT Filed: Jun. 21, 2011
(86) PCT No.: PCT/CN11/76048

§ 371 Date: Oct. 22, 2011

(30) Foreign Application Priority Data
May 30, 2011 (CN) 201110142739.2

(51) Int. Cl. G01N 25/72; G06F 19/00

(52) U.S. Cl. 702/40

(57) ABSTRACT

Disclosed are a detection method and a detection system for an array substrate. The method comprises: supplying power to data lines and/or gate lines of the array substrate continuously in a setting time; proceeding temperature sensing to the data line and/or the gate line of the array substrate and recording results of the temperature sensing; find defect points on the data lines and/or the gate lines according to the results of the temperature sensing. The skill solution provided by the present invention is capable of detecting the inner defects of the data lines and/or the gate lines of the array substrate for preventing defect products entering the follow-up processes to promote the production quality and avoid the waste.

### BACKGROUND OF THE INVENTION

1. Field of the Invention

The present invention generally relates to a liquid crystal display (LCD) manufacture technology, and more particularly to a detection method and a detection system for an array substrate.

2. Description of Prior Art

The manufacture of the TFT-LCD (thin-film transistor liquid-crystal display) comprises three major processes, the color film process, the array process and the cell process. In the array process after the layout is finished, the detection must be executed to the layout of the array substrate for guarantee of the product quality and prevents defect occurrences.

In prior arts, an open/short test or an AOI (Automatic Optical Inspection) is commonly utilized for the detection to the layout of the array substrate. The data lines and the gate lines are arranged in matrix on the array substrate. As the array substrate of FIG. 1 having m rows and n columns shown in FIG. 1, x1, x2, x3, x4, . . . xm represent m gate lines and y1, y2, y3, y4, . . . yn represent n data lines. Defects may exist inside these data lines and/or gate lines. For example, being hollow or having bubble results in defects of decreased density. However, the aforesaid detections of the open/short test or the AOI cannot detect the foregoing defects.

In the array process, once the products with the inner defects undetected inside the data lines or gate lines enter the follow-up processes, a mass waste unavoidably creates.

Consequently, there is a need to provide a detection method and a detection system for an array substrate to solve the existed issues of prior arts.

### SUMMARY OF THE INVENTION

An objective of the present invention is to provide a detection method and a detection system for an array substrate to solve the issues of the inner defects of the data line or/and the gate line by proceeding defect detection.

The invention is realized as described follow:

A detection method for an array substrate, comprising:

supplying power to at least one kind of control signal line of the array substrate continuously in a setting time;

proceeding temperature sensing to the control signal line supplied with power with a thermal imager and recording results of the temperature sensing, and the thermal imager establishes an infrared image picture after the temperature sensing to the control signal line is proceeded therewith;

confirming abnormal temperature data according to colors of the infrared image picture and taking points of the control signal line corresponding to the abnormal temperature data as defect points.

In one preferable embodiment of the present invention, the control signal line is a data line or a gate line on the array substrate.

In one preferable embodiment of the present invention, the step of proceeding the temperature sensing to the control signal line supplied with power and recording the results of the temperature sensing comprises: proceeding the temperature sensing point-to-point and recording the temperature data of the control signal line point-to-point.

In one preferable embodiment of the present invention, the step of proceeding the temperature sensing to the control signal line supplied with power and recording the results of the temperature sensing comprises: proceeding the temperature sensing to the whole control signal line supplied with power and recording the temperature data of the whole control signal line.

In one preferable embodiment of the present invention, the detection method further comprises a step of clearing the defect points of the control signal line and filling the defect point with material of forming the control signal line.

The present invention further provides another detection method for an array substrate, comprising:

supplying power to at least one kind of control signal line continuously in a setting time;

proceeding temperature sensing to the control signal line supplied with power and recording results of the temperature sensing;

searching abnormal temperature data in the results of the temperature sensing to find points of the control signal line corresponding to the abnormal temperature data and take the points of the control signal line corresponding to the abnormal temperature data as defect points.

In one preferable embodiment of the present invention, the control signal line is a data line or a gate line on the array substrate.

In one preferable embodiment of the present invention, the step of proceeding the temperature sensing to the control signal line supplied with power and recording the results of the temperature sensing comprises: proceeding the temperature sensing point-to-point and recording the temperature data of the control signal line point-to-point; and the step of searching abnormal temperature data in the results of the temperature sensing comprises: comparing the temperature data of the control signal line and taking high temperature data as the abnormal temperature data.

In one preferable embodiment of the present invention, the step of proceeding the temperature sensing to the control signal line supplied with power and recording the results of the temperature sensing comprises: proceeding the temperature sensing to the whole control signal line supplied with power and recording the temperature data of the whole control signal line; and the step of searching abnormal temperature data in the results of the temperature sensing comprises: searching points having amplitude change in temperature profile and taking temperature data of the points having amplitude change as the abnormal temperature data.

In one preferable embodiment of the present invention, the detection method further comprises proceeding the temperature sensing to the control signal line supplied with power with a thermal imager, and the thermal imager establishes an infrared image picture after the temperature sensing is proceeded therewith; and confirming abnormal temperature data according to colors of the infrared image picture and finding the points of the control signal line corresponding to the abnormal temperature data.

In one preferable embodiment of the present invention, the detection method further comprises a step of clearing the defect points of the control signal line and filling the defect point with material of forming the control signal line.

In one preferable embodiment of the present invention, the step of proceeding the temperature sensing to the control signal line supplied with power and recording the results of the temperature sensing comprises: proceeding the temperature sensing to gate lines after the gate lines are formed on the array substrate; and proceeding the temperature sensing to data lines after the data lines are formed on the array substrate.

In one preferable embodiment of the present invention, the step of proceeding the temperature sensing to the control signal line supplied with power and recording the results of the temperature sensing comprises: proceeding the temperature sensing to gate lines and data lines at the same time after the gate lines and the data lines are formed on the array substrate.

The present invention further provides a detection system of an array substrate, comprising:

a power source, supplying power to at least one kind of control signal line of the array substrate through a detection circuit;

the detection circuit, connecting the power source and the control signal line to let the power source supply power to the control signal line and input current; and

a temperature sensing device, proceeding temperature sensing of respective points of the control signal line supplied with power after a setting time to record and show results of the temperature sensing.

In one preferable embodiment of the present invention, the temperature sensing device is a thermal imager to sense the temperature of the control signal line supplied with power after the setting time, and to establish an infrared image picture corresponding to the control signal line.

Being compared with prior arts, the detection method and the detection system provided by the present invention is capable of detecting the inner defects of the data lines or/and the gate lines of the array substrate for preventing defect products entering the follow-up processes to promote the production quality and avoid the waste.

For a better understanding of the aforementioned content of the present invention, preferable embodiments are illustrated in accordance with the attached figures for further explanation:

### BRIEF DESCRIPTION OF THE DRAWINGS

FIG. 1 depicts a diagram of layout of the data lines and the gate lines of an array substrate according to prior art;

FIG. 2 depicts a flow chart of a detection method for an array substrate according to the first preferable embodiment of the present invention;

FIG. 3 depicts a diagram of an infrared image picture provide by the present invention;

FIG. 4 depicts a flow chart of a detection method for an array substrate according to the second preferable embodiment of the present invention;

FIG. 5 depicts a block diagram of a preferable embodiment of a detection system for an array substrate provided by the present invention.

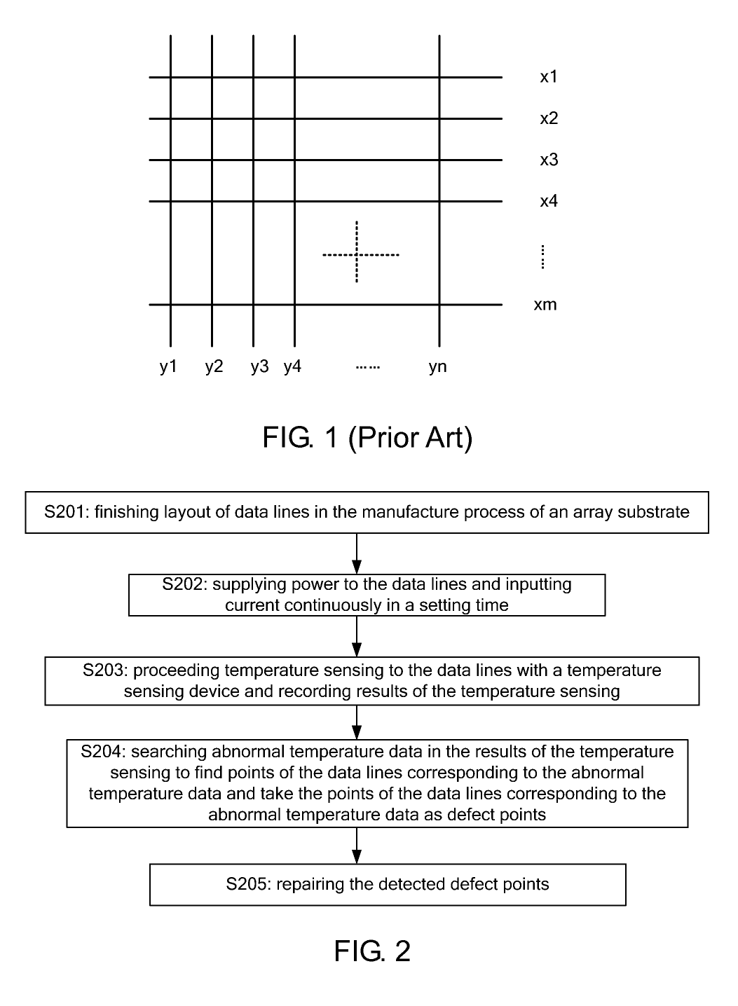

### DETAILED DESCRIPTION OF THE INVENTION

The following descriptions for the respective embodiments are specific embodiments capable of being implemented for illustrations of the present invention with referring to appended figures. For example, the terms of up, down, front, rear, left, right, interior, exterior, side, etcetera are merely directions of referring to appended figures. Therefore, the wordings of directions are employed for explaining and understanding the present invention but not limitations thereto.

In the embodiments of the present invention, data lines and gate lines on an array substrate are called control signal lines.

Please refer to FIG. 2, which depicts a flow chart of a detection method for an array substrate according to the first preferable embodiment of the present invention.

The detection method comprises steps of:

S201: finishing layout of data lines in the manufacture process of an array substrate;
S202: supplying power to the data lines and inputting current continuously in a setting time;
S203: proceeding temperature sensing to the data lines with a temperature sensing device and recording results of the temperature sensing;
S204: searching abnormal temperature data in the results of the temperature sensing to find points of the data lines corresponding to the abnormal temperature data, and take the points of the data lines corresponding to the abnormal temperature data as defect points;
S205: repairing the detected defect points.

In the aforesaid process, supplying power to the data lines can be executed line by line. The data line will have a certain heat quantity due to the inputted current. After the certain heat quantity is accumulated on one data line due to the inputted current, then the temperature sensing is proceeded to the data line. Alternatively, supplying power can be executed to all the data lines at the same time. After the certain heat quantity is accumulated on all the data lines due to the inputted currents, then the temperature sensing is proceeded to the data lines. After that, defect points of the data lines can be found according to the results of the temperature sensing.

In Step S203, the temperature sensing device can be employed to proceed temperature sensing to the data lines point-to-point and record the temperature data of respective points. In Step S204, searching abnormal temperature data can be implemented by comparing the recorded temperature data of the respective points. In the data lines, being hollow or having bubble therein results in the smaller density of the data line and larger resistance at the defect point. After supplying power in a setting time, the temperature rise will be larger than the non-defect points. Once the temperature data of one or more points are found to be larger than others, the corresponding point of the data line can be confirmed having a defect. If the temperature data of the respective points are the same, the corresponding data line can be confirmed having no defects.

In Step S203, the temperature sensing device can be employed to proceed temperature sensing to the whole data line and derive the temperature profile of the data line (the temperature profile comprises corresponding coordinates of the respective points). The temperature data of the respective points are roughly the same in case that the corresponding data line has no defects. The temperature profile approximates a straight line. The data line has a defect in case that an amplitude change occurs in the temperature profile. By checking the coordinates of the point having the temperature variation to locate the point on the corresponding data line, the position of the defect point can be found.

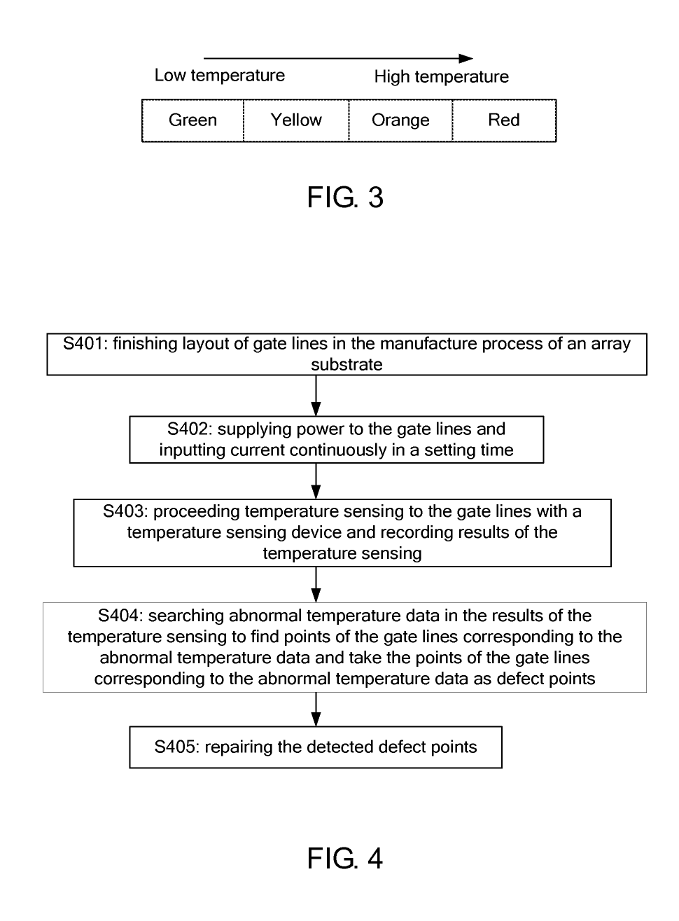

The temperature sensing device can be a thermal imager. The thermal imager receives the infrared ray of the data line after the temperature rise and establishes an infrared image picture as shown in FIG. 3. Different colors in the infrared image picture represent the temperature of the respective points of the corresponding data line. The temperature rises and the radiations on the whole data line are the same in case that the corresponding data line has no defects inside. The colors in the infrared image picture are the same or similar. Once the temperatures corresponding to the colors of some portions in the infrared image picture are found to be larger than others, the corresponding data line can be confirmed having a defect. Moreover, the defect points can be found and located according to the high temperature points in the infrared image picture.

Specifically in Step S205, repairing the detected defect points can be implemented by clearing the defect points detected in Step S204, and then filling the defect point with material of forming the data line to complete the repair of the defect.

Please refer to FIG. 4, which depicts a flow chart of a detection method for an array substrate according to the second preferable embodiment of the present invention. The detection method comprises steps of:

S401: finishing layout of gate lines in the manufacture process of an array substrate;
S402: supplying power to the gate lines and inputting current continuously in a setting time;
S403: proceeding temperature sensing to the gate lines with a temperature sensing device and recording results of the temperature sensing;
S404: searching abnormal temperature data in the results of the temperature sensing to find points of the gate lines corresponding to the abnormal temperature data and take the points of the gate lines corresponding to the abnormal temperature data as defect points;
S405: repairing the detected defect points.

In the aforesaid process, supplying power to the gate lines can be executed line by line. The gate line will have a certain heat quantity due to the inputted current. After the certain heat quantity is accumulated on one gate line due to the inputted current, then the temperature sensing is proceeded to the gate line. Alternatively, supplying power can be executed to all the gate lines at the same time. After the certain heat quantity is accumulated on all the gate lines due to the inputted currents, then the temperature sensing is proceeded to the gate lines. After that, defect points of the gate lines can be found according to the results of the temperature sensing.

In Step S403, the temperature sensing device can be employed to proceed temperature sensing to the gate lines point-to-point and record the temperature data of respective points. In Step S404, searching abnormal temperature data can be implemented by comparing the recorded temperature data of the respective points. In the gate lines, being hollow or having bubble therein results in the smaller density of the gate line and larger resistance at the defect point. After supplying power in a setting time, the temperature rise will be larger than the non-defect points. Once the temperature data of one or more points are found to be larger than others, the corresponding point of gate line can be confirmed having a defect. If the temperature data of the respective points are the same, the corresponding gate line can be confirmed having no defect.

In Step S403, the temperature sensing device can be employed to proceed temperature sensing to the whole gate line and derive the temperature profile of the gate line (the temperature profile comprises corresponding coordinates of the respective points). The temperature data of the respective points are roughly the same in case that the corresponding gate line has no defects. The temperature profile approximates a straight line. The gate line has a defect in case that an amplitude change occurs in the temperature profile. By checking the coordinates of the point having the temperature variation to locate the point on the corresponding gate line, the position of the defect point can be found.

Specifically in Step S405, repairing the detected defect points can be implemented by clearing the defect points detected in Step S404, and then filling the defect point with material of forming the gate line to complete the repair of the defect.

The temperature sensing device can be a thermal imager. The thermal imager receives the infrared ray of the gate line after the temperature rise and establishes an infrared image picture (shown in FIG. 3). Different colors in the infrared image picture represent the temperature of the respective points of the corresponding gate line. Once the temperatures corresponding to the colors of some portions in the infrared image picture are found to be larger than others, the corresponding gate line can be confirmed having a defect. Moreover, the defect points can be found and located according to the high temperature points in the infrared image picture.

In the manufacture process of an array substrate, the gate lines are generally formed first and the data lines are formed thereafter. Specifically, the present invention is applied, either of the following procedures illustrated for the detection and repair for the gate line/data line can be employed:

1. After the gate lines are formed, the detection is executed to the gate lines. The defect point of the gate lines will be repaired if the defect point is detected, and then the data lines are formed. After the data lines are formed, the detection is executed to the data lines. The defect point of the data lines will be repaired if the defect point is detected.
2. The gate lines are formed, and then the data lines are formed. The detection for the defect point is executed to the gate lines and the data lines at the same time. The defect point of gate lines and/or data lines will be repaired if the defect point of gate lines and/or data lines is detected.
3. The gate lines are formed, and then the data lines are formed. First, the detection to the gate lines is executed. Then, the detection to the data lines is executed. And then, the defect point (if detected) of gate lines and data lines will be repaired. The subsequence of repair is not restricted. Either the defect point of the gate lines or that of the data lines can be repaired in advance.
4. The gate lines are formed, and then the data lines are formed. First, the detection to the data lines is executed. Then, the detection to the gate lines is executed. And then, the defect point (if detected) of gate lines and data lines will be repaired. The subsequence of repair is not restricted. Either the defect point of the gate lines or that of the data lines can be repaired in advance.

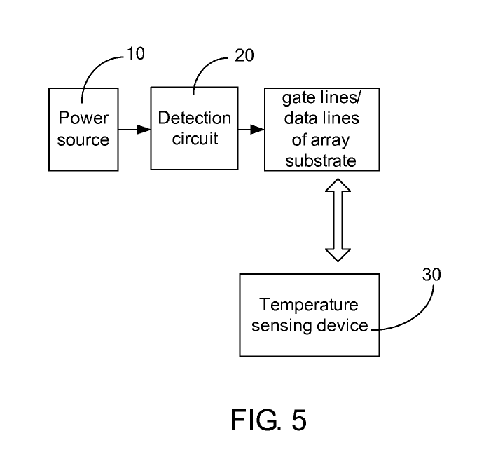

FIG. 5 depicts a block diagram of a preferable embodiment for a detection system 100 for an array substrate provided by the present invention. The detection system 100 comprises a power source 10, a detection circuit 20 and a temperature sensing device 30. The power source 10 is coupled to the detection circuit 20 to supply power to the data lines and/or gate lines of the array substrate through the detection circuit 20.

The detection circuit 20 is coupled to the power source and the data lines and/or gate lines of the array substrate. The detection circuit 20 is employed for coupling the power source and the data lines and/or gate lines to let the power source supply power to the data lines and/or gate lines and input current.

The temperature sensing device 30 is employed to proceed temperature sensing of respective points of the data lines and/or gate lines supplied with power after a setting time. The temperature sensing device 30 records and shows results of the temperature sensing.

The temperature sensing device 30 can be a thermal imager. The thermal imager receives the infrared ray of the data lines/gate lines after the temperature rise and establishes an infrared image picture (shown in FIG. 3). Different colors in the infrared image picture represent the temperature of the respective points of the corresponding data lines and/or gate lines. Accordingly, the corresponding data lines and/or gate lines can be confirmed having a defect or not. Moreover, the defect points can be found and located according to the high temperature points in the infrared image picture.

As aforementioned, with the detection method and the detection system for the array substrate according to the present invention, after the layout of the array substrate is finished, power is supplied to the data lines and/or gate lines in a setting time. Then, the temperature sensing is proceeded to the data lines and/or gate lines of the array substrate. The inner defects of the data lines and/or the gate lines can be detected by searching the abnormal temperature data. Significantly, the detection method and the detection system for the array substrate provided by the present invention is capable of detecting the inner defects of the data lines and/or the gate lines of the array substrate for preventing defect products entering the follow-up processes to promote the production quality and avoid the waste.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A detection method for an array substrate, comprising:
supplying power to at least one kind of control signal line of the array substrate continuously in a setting time;
proceeding temperature sensing to the control signal line supplied with power with a thermal imager and recording results of the temperature sensing, and the thermal imager establishes an infrared image picture after the temperature sensing to the control signal line is proceeded therewith; and
confirming abnormal temperature data according to colors of the infrared image picture and taking points of the control signal line corresponding to the abnormal temperature data as defect points.

2. The detection method of claim 1, wherein the control signal line is a data line or a gate line on the array substrate.

3. The detection method of claim 1, wherein the step of proceeding the temperature sensing to the control signal line supplied with power and recording the results of the temperature sensing comprises: proceeding the temperature sensing point-to-point and recording the temperature data of the control signal line point-to-point.

4. The detection method of claim 1, wherein the step of proceeding the temperature sensing to the control signal line supplied with power and recording the results of the temperature sensing comprises: proceeding the temperature sensing to the whole control signal line supplied with power and recording the temperature data of the whole control signal line.

5. The detection method of claim 1, wherein the detection method further comprises a step of clearing the defect points of the control signal line and filling the defect point with material of forming the control signal line.

6. A detection method for an array substrate, comprising:
supplying power to at least one kind of control signal line continuously in a setting time;
proceeding temperature sensing to the control signal line supplied with power and recording results of the temperature sensing; and
searching abnormal temperature data in the results of the temperature sensing to find points of the control signal line corresponding to the abnormal temperature data and take the points of the control signal line corresponding to the abnormal temperature data as defect points.

7. The detection method of claim 6, wherein the control signal line is a data line or a gate line on the array substrate.

8. The detection method of claim 6, wherein the step of proceeding the temperature sensing to the control signal line supplied with power and recording the results of the temperature sensing comprises: proceeding the temperature sensing point-to-point and recording the temperature data of the control signal line point-to-point; and the step of searching abnormal temperature data in the results of the temperature sensing comprises: comparing the temperature data of the control signal line and taking high temperature data as the abnormal temperature data.

9. The detection method of claim 6, wherein the step of proceeding the temperature sensing to the control signal line supplied with power and recording the results of the temperature sensing comprises: proceeding the temperature sensing to the whole control signal line supplied with power and recording the temperature data of the whole control signal line; and the step of searching abnormal temperature data in the results of the temperature sensing comprises: searching points having amplitude change in temperature profile and taking temperature data of the points having amplitude change as the abnormal temperature data.

10. The detection method of claim 6, wherein the detection method further comprises proceeding the temperature sensing to the control signal line supplied with power with a thermal imager, and the thermal imager establishes an infrared image picture after the temperature sensing is proceeded therewith; and confirming abnormal temperature data according to colors of the infrared image picture and finding the points of the control signal line corresponding to the abnormal temperature data.

11. The detection method of claim 6, wherein the detection method further comprises a step of clearing the defect points of the control signal line and filling the defect point with material of forming the control signal line.

12. The detection method of claim 6, wherein the step of proceeding the temperature sensing to the control signal line supplied with power and recording the results of the temperature sensing comprises: proceeding the temperature sensing to gate lines after the gate lines are formed on the array substrate; and proceeding the temperature sensing to data lines after the data lines are formed on the array substrate.

13. The detection method of claim 6, wherein the step of proceeding the temperature sensing to the control signal line supplied with power and recording the results of the temperature sensing comprises: proceeding the temperature sensing to gate lines and data lines at the same time after the gate lines and the data lines are formed on the array substrate.

14. A detection system for an array substrate, comprising:
a power source, supplying power to at least one kind of control signal line of the array substrate through a detection circuit;
the detection circuit, coupling the power source and the control signal line to let the power source supply power to the control signal line and input current; and
a temperature sensing device, proceeding temperature sensing of respective points of the control signal line supplied with power after a setting time to record and show results of the temperature sensing.

15. The detection system of claim 14, wherein the temperature sensing device is a thermal imager to sense the temperature of the control signal line supplied with power after the setting time, and to establish an infrared image picture corresponding to the control signal line.
